(19) United States
(12) Patent Application Publication
(10) Pub. No.: US 2012/0094508 A1
(43) Pub. Date: Apr. 19, 2012

(54) Adapter with simple configuration

(75) Inventors: XUN-SAN TAO, Kunshan (CN); HONG-QIANG HAN, Kunshan (CN); ZI-QIANG ZHU, Kunshan (CN)

(73) Assignee: HON HAI PRECISION INDUSTRY CO., LTD., New Taipei (TW)

(21) Appl. No.: 13/210,396

(22) Filed: Aug. 16, 2011

(30) Foreign Application Priority Data
Oct. 14, 2010 (CN) 201020561716.6

(51) Int. Cl. H01R 12/51

(52) U.S. Cl. 439/76.1

(57) ABSTRACT

An adapter comprises a PCB assembly, a first connector mounted on the PCB assembly, a plurality of second connectors mounted on the PCB assembly and a cover shielding the PCB assembly mounted with the first connector and the second connectors. The PCB assembly has a plurality of conductive traces, the first connector and the second connectors electrically connecting with each other via the PCB assembly to convert signals therebetween, and the first connector is a diiva connector.

### BACKGROUND OF THE INVENTION

1. Field of the Invention

The present invention is generally related to an adapter, and especially to an adapter which can convert signals between many different equipments and having a simple configuration.

2. Description of Related Art

Many connectors are used to transmit audio signals, video signals, and data signals between varied electrical equipments on the market, and manufacturers also produce many kinds of adapters to convert signals between two different connectors. Such an adapter usually includes a PCB (printed circuit board), a first connector soldered on the PCB and a second connector soldered on the PCB, the first and the second connectors achieve signal transmissions between different equipments via the PCB.

However, following the development of electronic industry, more and more different kinds of consume electronic equipments appear to the market, people need communications between the electronic equipments, such as video signal transmission between TV, computer, game player, DVD, etc. And above adapter only capable of providing signal conversion between two different connectors can not be advisable.

Hence, an improved adapter is highly desired to overcome the aforementioned disadvantages of the prior art.

### SUMMARY OF THE INVENTION

Accordingly, an object of the present invention is to provide an adapter with a simple configuration.

To fulfill the above object, an adapter comprises a PCB assembly, a first connector mounted on the PCB assembly, a plurality of second connectors mounted on the PCB assembly, and a cover shielding the PCB assembly mounted with the first connector and the second connectors. The PCB assembly has a plurality of conductive traces, and the first connector and the second connectors electrically connecting with each other via the PCB assembly.

Other objects, advantages and novel features of the present invention will be drawn from the following detailed description of a preferred embodiment of the present invention with attached drawings.

### BRIEF DESCRIPTION OF THE DRAWINGS

FIG. 1 is an assembled, perspective view of an adapter in a preferred embodiment according to present invention;

FIG. 2 is a partly explored, perspective view of the adapter in FIG. 1;

FIG. 3 is similar with FIG. 2, but taken from another side;

FIG. 4 is an another explored, perspective view of the adapter in FIG. 1; and

FIG. 5 is similar with FIG. 4, but taken from another side.

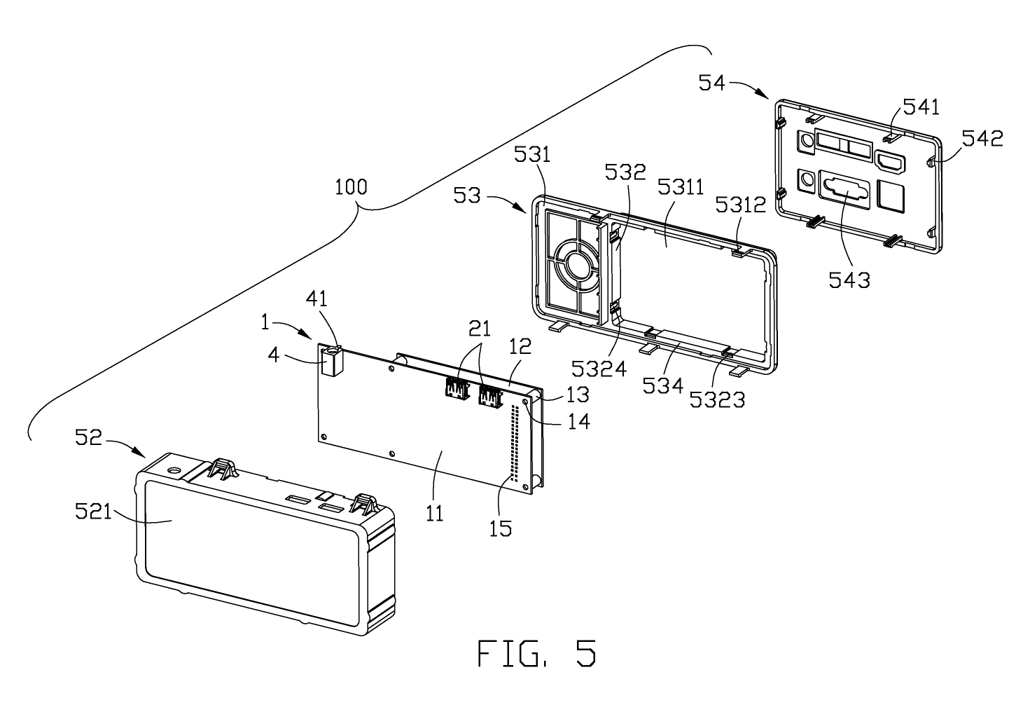

### DETAILED DESCRIPTION OF THE INVENTION

Reference will now be made in detail to the preferred embodiment of the present invention.

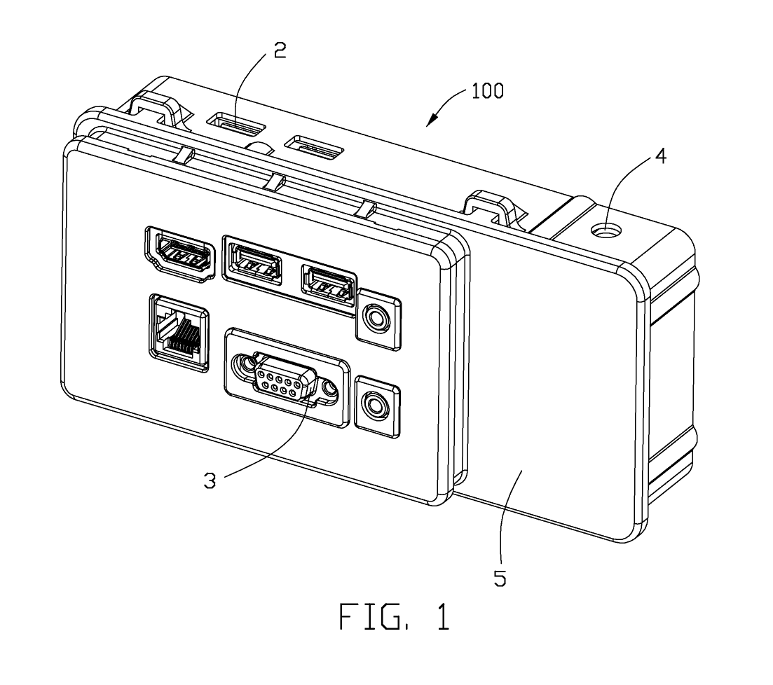

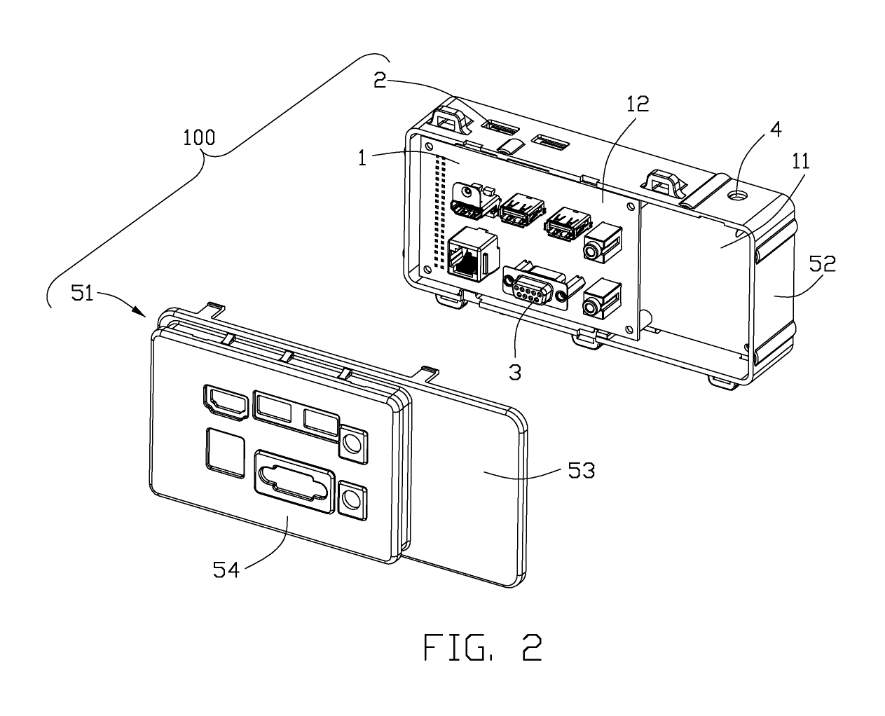

Referring to FIGS. 1-2, an adapter 100 in accordance with present invention can be called as wall plate, the adapter 100 can be mounted to a wall of a construction and electrically connects with a cable assembly (not shown) mounted within the wall. The adapter 100 includes a printed circuit board (PCB) assembly 1, two first connectors 2 soldered to the PCB assembly 1 for mating with first mating connectors (not shown), a plurality of second connector 3 soldered to the PCB assembly 1 for mating with second mating connectors (not shown), a Power Jack connector 4 welded to the PCB assembly 1, and a cover 5 shielding the PCB assembly 1, the first connectors 2, the second connectors 3 and the Power Jack connector 4.

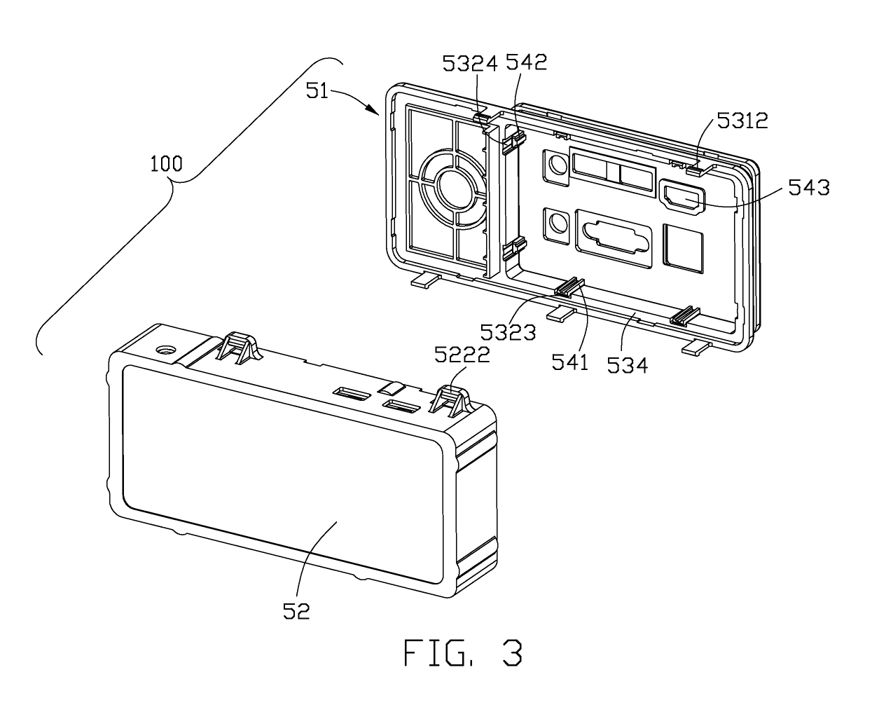

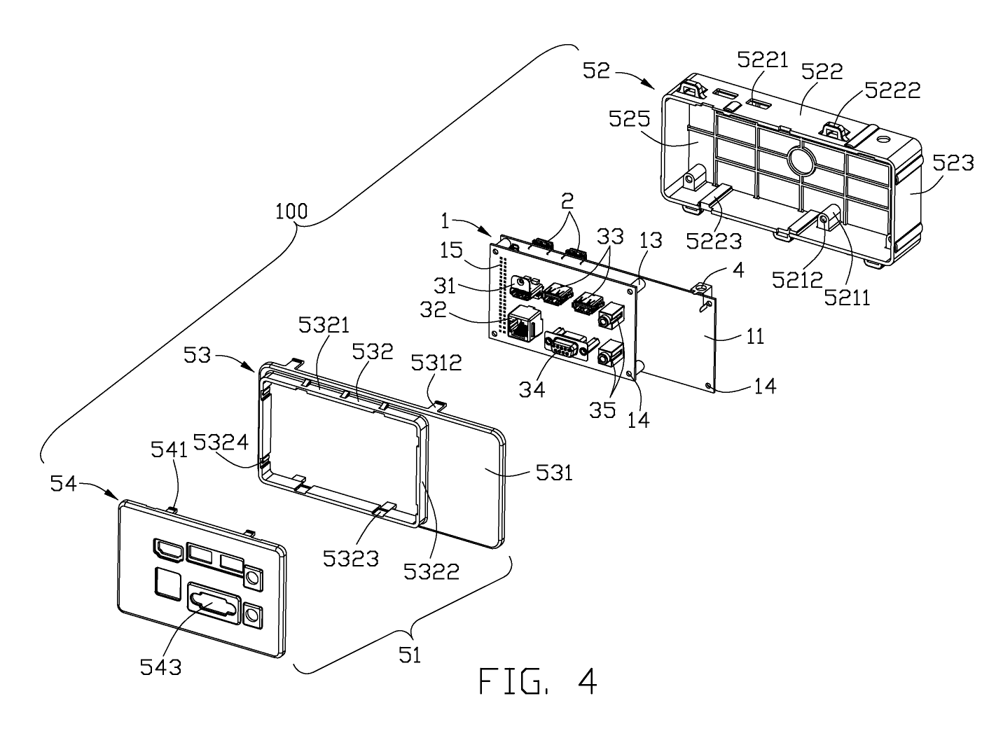

Referring to FIGS. 3-4, the PCB assembly 1 includes a first PCB 11 on which the first connectors 2 and the Power Jack connector 4 are mounted, a second PCB 12 on which the second connectors 3 are mounted, and a Board to Board connector (not shown) electrically connecting the first PCB 11 and the second PCB 12 to transmit signals and a plurality of bolts 13 liking the first and the second PCBs 11, 12. The first and the second PCBs 11, 12 both have a rectangular configuration and are parallel to each other along a front to back direction.

The first PCB 11 has a length along a longitudinal direction of the adapter 100 longer that that of the second PCB 12, and the second PCB 12 completely overlaps the first PCB 11 along the front to rear direction to reduce a dimension of the adapter 100. The first and the second PCBs 11, 12 each defines a plurality of circular holes 14 for the bolt 13 passing through to retain the first and the second PCBs 11, 12 together, and a plurality of first soldering holes 15 through the first and the second PCBs 11, 12 along the front to the rear direction for soldering with the Board and Board connector.

The first PCB 11 further has a plurality of conductive pads (not shown) for soldering with the first connectors 2 and the Power Jack connector 4 and a plurality of first conductive trace (not shown) for electrically connecting the conductive pads with the Broad to Board connector. The second PCB 12 defines a plurality of second soldering holes (not shown) for soldering with the second connectors 3 and a plurality of second conductive traces (not shown) for electrically connecting the second soldering holes with the Broad to Board connector. The PCB assembly 1 has an IC package (not shown) for saving and transmitting data, so that signals transmission can be processed between the first connectors 2 and the second connectors 3.

In present embodiment, the first connector 2 is a Diiva (Digital Interactive Interface for Video & Audio) receptacle soldered to the first PCB 11 by surface mounting technology to mate with a Diiva plug, which is above said first mating connector. The first connector 2 has a first mating surface 21 upwardly exposed for mating with the first mating connector. The Power Jack connector 4 has a front surface 41 for mating with a power plug (not shown).

The second connectors 3 are vertically soldered to the second soldering holes of the second PCB 12 to transmit signals to the first connector 2 in virtue of the PCB assembly 1. The second connectors 3 include a HDMI receptacles 31, a RJ 45 connector 32 under the HDMI receptacle 31, two USB receptacles 33 arranged side by side and both located on a right side of the HDMI receptacle 31, a D-sub connector 34 under the receptacles 33 and two Audio Jacks 35 arranged along a top to bottom direction and both located on a right side of USB receptacles 33.

The cover 5 includes a front shell 51 and a rear shell 52 assembled to each other along the front to rear direction, and the rear shell 52 receives the PCB assembly 1 with all the connectors, including the first connectors 2, the second connectors 3, the Power Jack connector 4, etc, from a rear side. The front shell 51 latches with the rear shell 52 from a front side to shield the PCB assembly 1 and the connectors.

The front shell 51 further comprises a frame 53 and a plate 54. The frame 53 has a base 531 engaging with the rear shell 53 and defining a through window 5311 for mounting and receiving the plate 54, and a flange 532 extending forwardly from a peripheral of the opening 5311 to surround the plate 54. A ring-like step 534 is formed between the base 531 and the flange 532 to abut against a front of the rear shell 52 to prevent the rear shell 52 from forwardly moving.

The base 531 has a plurality of hooks 5312 extending backwardly to latch with the rear shell 52. The flange 532 has two opposed first walls 5321 along the longitudinal direction of the adapter 100 and two second walls 5322 linking the first walls 5321 along the top to bottom direction. The first wall 5321 defines a pair of latching recesses 5323 on an inner side thereof, and the second wall 5322 defines a pair of limiting recesses 5324 on an inner side thereof.

The plate 54 has a plurality of latching fingers 541 extending backwardly to latch with the latching recesses 5323 and a plurality of limiting portions 542 extending backwardly to resist inner walls of the limiting recesses 5323 to prevent the plate 54 from swinging in the longitudinal and the top to bottom directions. The second connectors 3 forwardly resist a rear surface of the plate 54, and the plate 54 defines a plurality of first openings 543 corresponding to the second connectors 3 to expose mating surfaces of the second connectors 3.

The rear shell 52 has a rear wall 521 and a peripheral wall forwardly extending from the rear wall 521. The peripheral wall includes two opposed first sidewalls 522 along the longitudinal direction of the adapter 100 and two second sidewalls 523 linking the first sidewalls 522 along the top to bottom direction. The first sidewall 522, the second sidewall 523 and the rear wall 521 define a cavity 525 for receiving the PCB assembly 1 mounted with the connectors.

The first sidewall 522 defines a plurality of second openings 5221 passing through sidewall 522 along the top to bottom direction and corresponding to the first connectors 2 and the Power Jack connector 4. The first connectors 2 and the Power Jack connector 4 are exposed to external through the second openings 5221 to mate with the first mating connector and the power plug.

The first sidewall 522 has a plurality of clasping portions 5222 extending outwardly to clasp the hooks 5312 to retain the front shell 51 and the rear shell 52 together. The rear wall 521 has a plurality of posts 5211 extending forwardly and corresponding to the bolts 13 so as to support the first PCB 11. The post 5211 defines a screw hole 5212, the bolt 13 passes through the post 5211 of the rear shell 52, and the circular hole 14 of the PCB assembly 1 to assemble the rear shell 52, the PCB assembly 1 together. The first sidewall 522 further has a plurality of ribs 5223 on an inner side thereof to resist two opposite sides of the PCB assembly 1 to prevent the PCB assembly 1 from swinging.

When the adapter 100 is mounted within the wall, the rear shell 52, the first connectors 1 and the Power Jack connector 4 are all received within the wall, the second connectors 3 are exposed forwardly, so people only need to dispose the first mating connectors connecting with the first connectors 2, the power plug connecting with connecting with the Power jack connector 4 and a cable assembly connecting with the first mating connectors and the power plug within the wall, and then the adapter 100 can convert signals between different connectors and electronic equipments.

In above embodiment, the adapter 100 has two first connectors 2 converting signals with the second connectors 3 via a PCB assembly 1, however, in other embodiment, the adapter may only have one first connector and convert signals with the second connectors 3 via only one PCB.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A adapter comprising:
a PCB assembly having a plurality of conductive traces;
a first connector mounted on the PCB assembly;
a plurality of second connectors mounted on the PCB assembly, and the first connector and the second connectors electrically connecting with each other via the PCB assembly; and
a cover shielding the PCB assembly mounted with the first connector and the second connectors.

2. The adapter as claimed in claim 1, wherein the first connector is exposed upwardly or downwardly for mating with a first mating connector, and the second connector is exposed forwardly for mating with second mating connectors.

3. The adapter as claimed in claim 2, wherein the PCB assembly comprises a first PCB, a second PCB parallel to the first PCB along a front to rear direction, a Board to Board connector electrically connecting the first and the second PCBs and a plurality of colts retaining the first and the second PCB together.

4. The adapter as claimed in claim 3, wherein the second PCB completely overlaps the first along the front to rear direction.

5. The adapter as claimed in claim 3, wherein the PCB assembly has an IC package for saving and transmitting data.

6. The adapter as claimed in claim 3, wherein the first connector is mounted on the first PCB, and the second connectors are mounted on the second PCB, the first connector is a diiva (Digital Interactive Interface for Video & Audio) connector, the second connectors are many different kinds connectors, but not a diiva connector.

7. The adapter as claimed in claim 3, wherein the cover has a front shell and a rear shell assembled to the front shell along the front to rear direction, the rear shell defines a cavity to receive the PCB assembly mounted with the first and the second connectors and a second opening to expose a mating surface of the first connector, and the rear wall has a plurality of posts each with screw hole for the bolt passing through.

8. The adapter as claimed in claim 7, wherein the front shell is formed with a frame and a plate, the frame defines a through window to mount and receive the plate, and the plate has a plurality of second openings to expose mating surfaces of the second connectors.

9. The adapter as claimed in claim 7, wherein the rear shell has a plurality of clasping portions extending outwardly to clasp hooks formed on the front shell.

10. A adapter comprising:
a PCB having a plurality of conductive traces;
a first connector mounted on the PCB;
a plurality of second connectors mounted on the PCB, and the first connector and the second connectors electrically connecting with each other via the conductive traces; and
a cover shielding the PCB mounted with the first connector and the second connectors.

11. The adapter as claimed in claim 10, wherein the first connector is a diiva (Digital Interactive Interface for Video & Audio) connector, and the second connectors comprises many other kinds connectors, one is a RJ 45 connector.

12. The adapter as claimed in claim 10, further comprising a Power Jack connector mounted on the PCB.

13. The adapter as claimed in claim 10, wherein the cover has a front shell and a rear shell assembled to the front shell along the front to rear direction, the rear shell defines a cavity to receive the PCB mounted with the first and the second connectors and a second opening to expose a mating surface of the first connector.

14. The adapter as claimed in claim 13, wherein the front shell is formed with a frame and a plate, the frame defines a through window to mount and receive the plate, and the plate defines a plurality of second openings to expose mating surfaces of the second connectors.

15. An electrical connector assembly comprising:
a box defining a rectangular interior space surrounded by a plurality of exterior surfaces including a primary surface and a plurality of secondary surfaces;
a printed circuit board subassembly disposed in the interior space;
a DiiVA (Digital Interactive Interface for Video & Audio) receptacle connector mounted upon one side of the printed circuit board subassembly;
a plurality of other receptacle connectors mounted upon the other side of the printed circuit board subassembly and exposed upon the primary surface; and
a power jack assembled to the printed circuit board subassembly and exposed upon one of the secondary surfaces.

16. The electrical connector assembly as claimed in claim 15, wherein the printed circuit board subassembly includes a first printed circuit board and a second printed circuit board parallel to each other under condition that the plurality of other receptacle connectors are mounted to the second printed circuit board while the DiiVA receptacle connector and the power jack are mounted to the first printed circuit board.

17. The electrical connector assembly as claimed in claim 16, wherein the primary surface defines a raised portion where the plurality of other receptacle connectors are exposed under the condition that the second printed circuit board is shorter than the first printed circuit board for compliance with said raised portion.

18. The electrical connector assembly as claimed in claim 15, wherein the DiiVA receptacle connector is exposed upon said one of the secondary surface with the power jack.

19. The electrical connector assembly as claimed in claim 15, wherein the primary surface defines a raised portion where the plurality of other receptacle connectors are exposed.

20. The electrical connector assembly as claimed in claim 19, wherein the raised portion includes a plate which is discrete from remaining portions of the primary surface and defines a plurality of openings through which said plurality of other receptacles forwardly extend for exposure to an exterior.
